(19) United States
(12) Patent Application Publication
(10) Pub. No.: US 2018/0272681 A1
(43) Pub. Date: Sep. 27, 2018

(54) Method of Forming Three-Dimensional Decorative Cloth on Textile

(71) Applicant: Ching-Chang Yeh, New Taipei City (TW)

(72) Inventor: Ching-Chang Yeh, New Taipei City (TW)

(21) Appl. No.: 15/871,369

(22) Filed: Jan. 15, 2018

(30) Foreign Application Priority Data
Mar. 23, 2017 (TW) 106109825

(51) Int. Cl. B32B 37/02; B32B 37/12; B32B 38/10; B32B 38/00; B32B 7/06; B32B 7/12; B32B 5/02; B32B 27/10; B32B 27/12; B32B 27/40; B32B 38/16; C09J 175/04; C09J 7/35; C08G 18/71; C09J 9/00

(52) U.S. Cl. CPC B32B 37/02; C08G 2170/20; B32B 37/1207; B32B 38/10; B32B 38/145; B32B 7/06; B32B 7/12; B32B 5/026; B32B 27/10; B32B 27/12; B32B 27/40; B32B 38/162; C09J 175/04; C09J 7/35; C08G 18/71; C09J 9/00; B32B 2037/1215; B32B 2255/02; B32B 2255/26; B32B 2437/00; B32B 2451/00; B32B 37/1292

(57) ABSTRACT

A method of forming a three-dimensional decorative cloth on a textile comprising steps of: providing a release paper, coating corrosion-resistant adhesive on the release paper in a screen printing manner, drying the corrosion-resistant adhesive; providing a decorative cloth, adhering the corrosion-resistant adhesive of the release paper on the decorative cloth in a heat transfer printing manner; providing a textile, forming an anticorrosive protection layer on the textile, removing the release paper from the decorative cloth, adhering the corrosion-resistant adhesive of the decorative cloth with the anticorrosive protection layer of the textile in a heat pressing manner; forming a corrosion layer on the decorative cloth in a screen printing manner so as to corrode the decorative cloth; washing the textile by water so to eliminate the corrosion layer, and washing the textile by soap so as to remove corroded portion of the decorative cloth.

### FIELD OF THE INVENTION

The present invention relates to a method of forming a three-dimensional decorative cloth on a textile.

### BACKGROUND OF THE INVENTION

A conventional method of forming free-dimensional decorative patterns or shapes on a decorative cloth contains burning out by carbonizing cellulose fibers.

In the burning out step, patterns are formed on silk, nylon, rayon, or cotton by using corrosive.

In a heat treatment, the cellulose fibers are carbonized and are washed so as to remove carbonized portion.

A conventional method of cutting cloth contains coating corrosive on cut portion of the cloth, drying and heating the cloth so as to eliminate carbonized portion of the cloth, and coating a binder along a peripheral side of the cut portion so as to dry the cut portion.

A conventional method of forming a decorative cloth on a textile containing using polyester cloth comprised of denaturing polyester fiber and non-denatured polyester fiber so as to form patterns on corrosion portion and non-corrosion portion. When forming decorative cloth on the textile, the decorative cloth is fixed on the textile, and wherein when a size of the decorative cloth is more than that of the textile, the decorative is cut in a desired shape.

However, the decorative cloth has to be fixed on the textile arcuately as its size is more than the textile. When a size of the decorative cloth is more than that of the textile, it is troublesome to cot the decorative cloth manually.

As adhering a decorative cloth on a textile, adhesive penetrates into the textile to cause unstable adhesion, for example, the decorative cloth removes from the textile easily.

The present invention has arisen to mitigate and/or obviate the afore-described disadvantages.

### SUMMARY OF THE INVENTION

The primary aspect of the present invention is to provide a method of forming a three-dimensional decorative cloth on a textile which adhere the decorative cloth with the textile firmly.

To obtain the above aspect, a method of forming a three-dimensional decorative cloth on a textile provided by a preferred embodiment the present invention contains steps of:

providing a release paper, coating corrosion-resistant adhesive on one surface of the release paper in a screen printing manner, drying the corrosion-resistant adhesive;

providing a decorative cloth, adhering the corrosion-resistant adhesive of the release paper on one surface of the decorative cloth in a heat transfer printing manner;

providing a textile, forming an anticorrosive protection layer on one surface of the textile, removing the release paper from the decorative cloth, adhering the corrosion-resistant adhesive of the decorative cloth with the anticorrosive protection layer of the textile in a heat pressing manner;

forming a corrosion layer on the decorative cloth in a screen printing manner so as to corrode the decorative cloth; and

washing the textile by water so to eliminate the corrosion layer, and washing the textile by soap so as to remove corroded portion of the decorative cloth.

In another embodiment, a method of forming a three-dimensional decorative cloth on a textile provided by a preferred embodiment the present invention contains steps of:

### BRIEF DESCRIPTION OF THE DRAWINGS

FIG. 1 is a flow chart showing a method of forming a three-dimensional decorative cloth on a textile according to a first embodiment of the present invention.

FIG. 2 is a schematic view showing screen printing a corrosion-resistant adhesive on a release paper and drying the corrosion-resistant adhesive according to the first embodiment of the present invention.

FIG. 3 is a schematic view showing adhering the release paper on the decorative cloth according to the first embodiment of the present invention.

FIG. 4 is a schematic view showing forming an anticorrosive protection layer on the textile according to the first embodiment of the present invention.

FIG. 5 is a schematic view showing removing the release paper from the decorative cloth and adhering the decorative cloth on the anticorrosive protection layer of the textile in a heat pressing manner according to the first embodiment of the present invention.

FIG. 6 is a schematic view showing screen printing a corrosion layer on the decorative cloth according to the first embodiment of the present invention.

FIG. 7 is a schematic view showing forming the three-dimensional decorative cloth on the textile according to the first embodiment of the present invention.

FIG. 8 is a flow chart showing a method of forming a three-dimensional decorative cloth on a textile according to a first embodiment of the present invention.

### DETAILED DESCRIPTION OF THE PREFERRED EMBODIMENTS

A method of forming three-dimensional decorative cloth on textile is applied for fabric products, such as T-shirts, shirts, pants, socks, bags, and handkerchiefs. The textile is knitwear comprised of rayon or cotton. Alternatively, the textile is acid-resistant fiber (such as silk or nylon) or a mixture of the acid-resistant fiber or cellulose fiber. Furthermore, the textile is non-woven cloth except for the knitwear.

The decorative cloth is any one of the textile, the knitwear, and the non-woven cloth. However, the decorative cloth is the knitwear made of the cellulose fiber in following embodiments of the present invention.

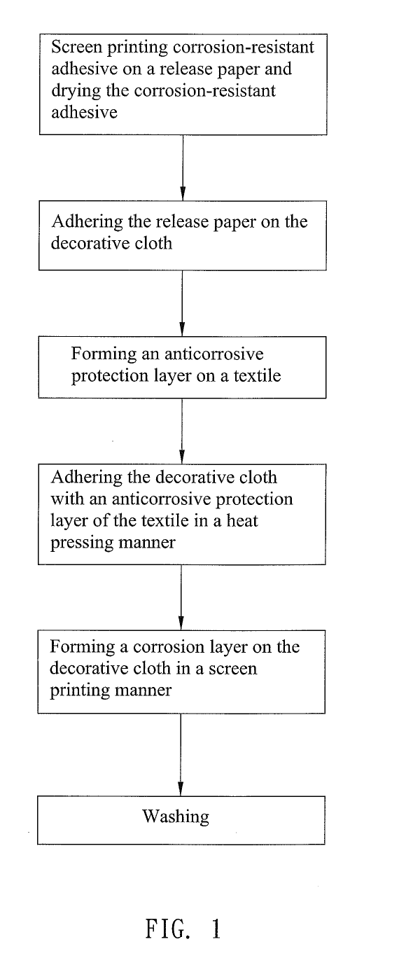

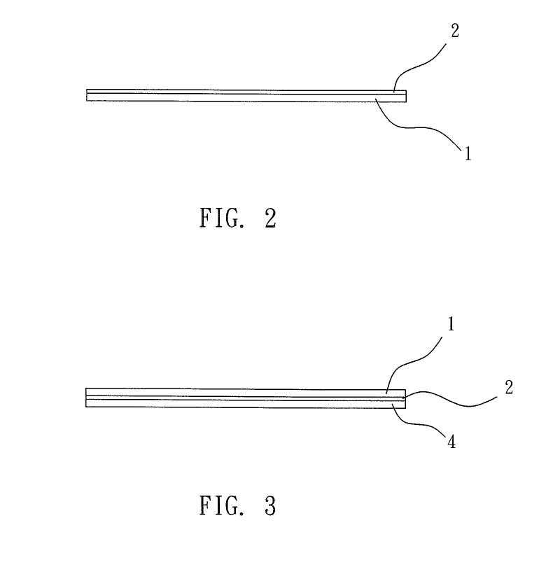

With reference to FIGS. 1-2, a method of forming the three-dimensional decorative cloth on the textile according to a first embodiment of the present invention comprises: providing a release paper 1, coating corrosion-resistant adhesive 2 on one surface of the release paper 1 in a screen printing manner, drying the corrosion-resistant adhesive 2 in a drying device (such as a heater), wherein the corrosion-resistant adhesive 2 has lye consisting of PUR hot melt adhesive and sodium bicarbonate (NaHCO₃), and a proportion of the PUR hot melt adhesive and the sodium bicarbonate depends on using requirements; thereafter adding anti-yellowing agent into the corrosion-resistant adhesive 2 so that the corrosion-resistant adhesive 2 forms on the release paper 1.

Referring to FIG. 3, to adhere the decorative cloth 4 on the textile 3, wherein the corrosion-resistant adhesive 2 on the release paper 1 is adhered on one surface of the decorative cloth 4, which adheres with the textile 3 in a heat transfer printing manner (i.e., in a heat pressing manner) so that the one surface of the decorative cloth 4 covers the release paper 1 by way of the corrosion-resistant adhesive 2.

The corrosion-resistant adhesive 2 is polyurethane reactive adhesives (PUR) and a main chain of its molecular chain consists of a functional group of carbamate group (—NFCOO—) or isocyanate group (—NCO) and a functional group of a side chain is polypropylene (PP), acrylic, and polydimethylsiloxane, wherein the corrosion-resistant adhesive 2 is coated on the release paper 1 by using a circular plate, the corrosion-resistant adhesive 2 acts, extends and generates cross-linked network with moisture in gas and has polymer solid polymer so as to obtain high adhesion, wherein the chemical formula of the corrosion-resistant adhesive 2 is:

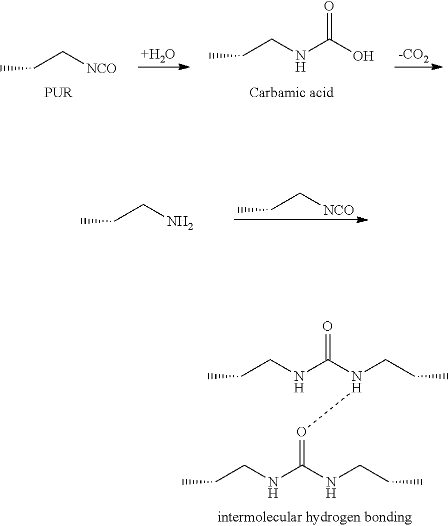

In this embodiment, the corrosion-resistant adhesive 2 adheres the decorative cloth 4 on the textile 3 so that an adhesion force of the decorative cloth 4 and the textile 3 is 4 Kg/cm².

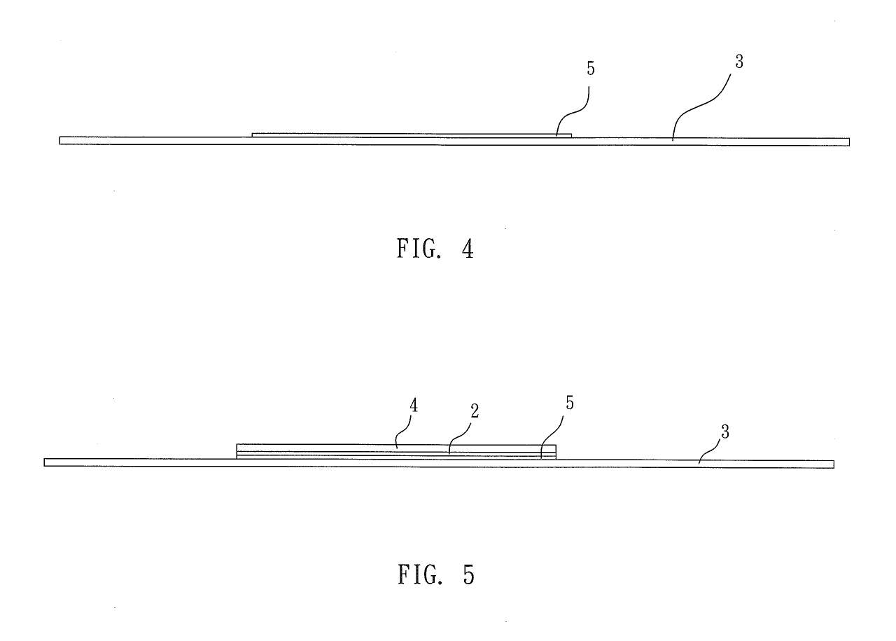

Referring further to FIG. 4, the textile 3 has an anticorrosive protection layer 5 formed on one surface thereof connecting with the decorative cloth 4 in a screen printing manner, wherein a profile of the anticorrosive protection layer 5 corresponds to the decorative cloth 4, the anticorrosive protection layer 5 consists of sodium bicarbonate, and the decorative cloth 4 connects with the textile 3.

As shown in FIG. 5, the release paper 1 is removed from the decorative cloth 4 so as to expose the corrosion-resistant adhesive 2, the corrosion-resistant adhesive 2 adheres with the anticorrosive protection layer 5 on the textile 3, and the decorative cloth 4 and the textile 3 are adhered firmly in a heat pressing manner.

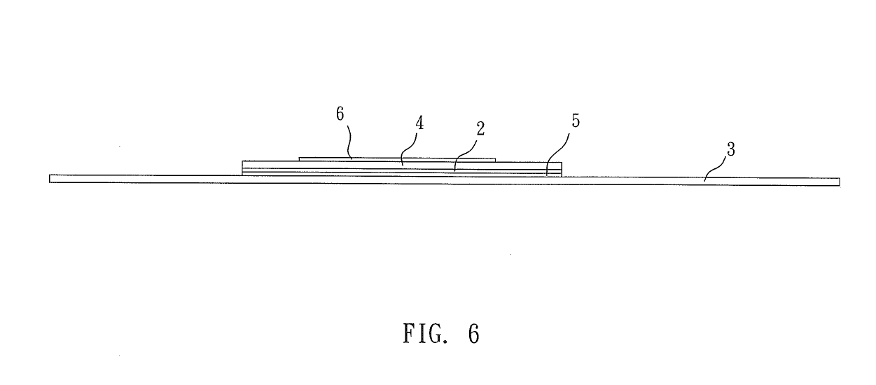

Thereafter, the decorative cloth 4 is burned out, as illustrated in FIG. 6, wherein the decorative cloth 4 has a corrosion layer 6 formed thereon in a screen printing manner so as to corrode the decorative cloth 4, and the corrosion layer 6 is made of trichloroacetic acid solution. After the trichloroacetic acid solution is screen printed on the decorative cloth 4, it corrodes the decorative cloth 4 for 15 minutes to 25 minutes within a temperature of 125° C. to 135° C. so as to oxidize cotton cellulose of the decorative cloth 4 and to destroy non-crystalline area structure.

The corrosion layer 6 is made of strong oxidizing acid, such as nitric acid (HNO₃), sulfuric acid (H₂SO₄), manganic acid (H₂MnO₄), hypochlorous acid (HClO), chloric acid (HClO₃), bromic acid (HBrO₃), nitrous acid, oxalic acid (H₂C₂O₄), or ionic liquid so that glycosidic bond of cellulose is broken because of acid catalysis and hydrolysis, thus burning out the decorative cloth.

The ionic liquid forms hydrogen bond by way of hydroxyl of chloride and cellulose so as to reduce hydrogen bond force in molecular, thus dissolving the cellulose in the ionic liquid as shown below:

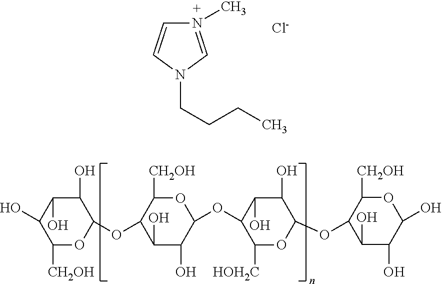

In above-shown reaction, harmful gas, fumes, and pollution does not produce so as to protect environment.

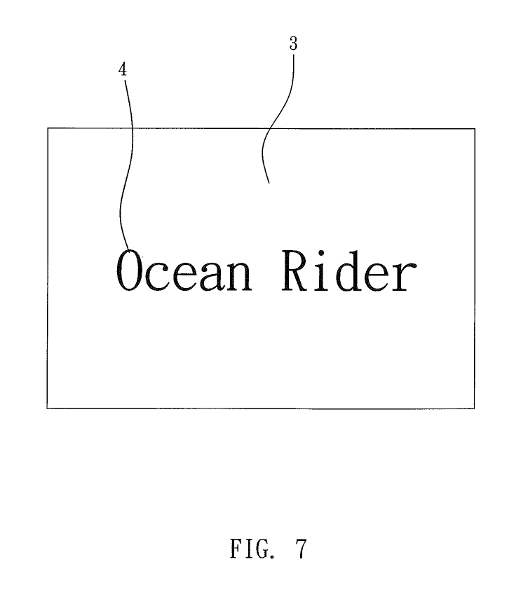

In a washing step of the method, the textile 3 is washed by water so as to eliminate the corrosion layer 6, thereafter the textile 3 is washed by soap so as to remove corroded portion of the decorative cloth 4, thus forming patterns, shape, letters on the textile 3, as shown in FIG. 7.

A method of forming three-dimensional decorative cloth on textile of a second embodiment from that of the first embodiment comprises: after adhering the corrosion-resistant adhesive 2 of the release paper 1 on the decorative cloth 4, cutting desired shape of the release paper 1 and the decorative cloth 4 by using a digital engraving machine, removing the release paper 1 from the decorative cloth 4, and adhering the decorative cloth 4 on the anticorrosive protection layer 5 on the textile 3.

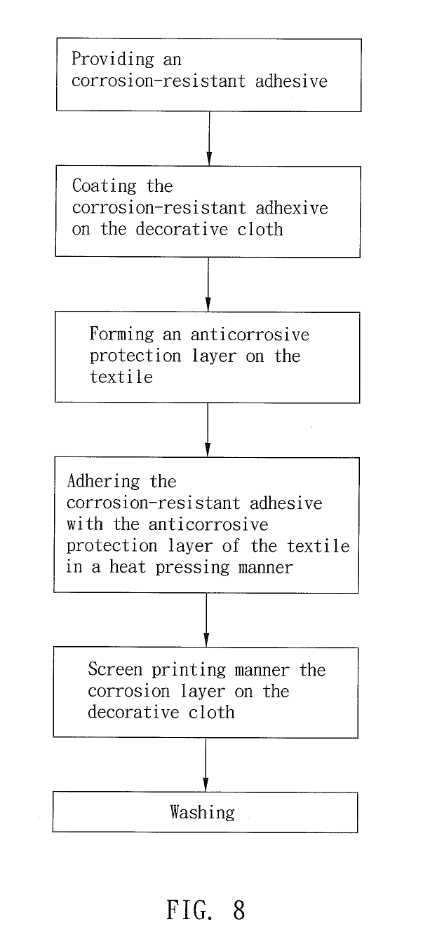

With reference to FIG. 8, the method of the second embodiment comprises a step of providing a corrosion-resistant adhesive which has lye consisting of PUR hot melt adhesive and sodium bicarbonate (NaHCO₃), wherein a proportion of the PUR hot melt adhesive and the sodium bicarbonate depends on using requirements. In addition, adding anti-yellowing agent into the corrosion-resistant adhesive 2 so as to avoid yellowing on the textile 3 made of nylon.

Thereafter, the corrosion-resistant adhesive 2 is coated on the decorative cloth 4 and is adhered on one surface of the textile 3 in a heat transfer printing manner (i.e., in a heat pressing manner), and an anticorrosive protection layer 5 is formed on one surface of the textile 3 connecting with the decorative cloth 4 in a screen printing manner, wherein a profile of the anticorrosive protection layer corresponds to that of the decorative cloth 4, the anticorrosive protection layer consists of sodium bicarbonate, and the decorative cloth 4 connects with the textile 3.

Thereafter, the decorative cloth 4 is burned out, for example, the decorative cloth 4 has a corrosion layer 6 formed thereon in a screen printing manner so as to corrode the decorative cloth 4, and the corrosion layer 6 is made of trichloroacetic acid solution. After the trichloroacetic acid solution is screen printed on the decorative cloth 4, it corrodes the decorative cloth 4 for 15 minutes to 25 minutes within a temperature of 125° C. to 135° C. so as to oxidize cotton cellulose of the decorative cloth 4 and to destroy non-crystalline area structure.

The corrosion layer 6 is made of strong oxidizing acid, such as nitric acid (HNO₃), sulfuric acid (H₂SO₄), manganic acid (H₂MnO₄), hypochlorous acid (HClO), chloric acid (HClO₃), bromic acid (HBrO₃), nitrous acid, oxalic acid (H₂C₂O₄), or ionic liquid so that glycosidic bond of cellulose is broken because of acid catalysis and hydrolysis, thus burning out the decorative cloth.

In a washing step of the method, the textile 3 is washed by water so to eliminate the corrosion layer 6, thereafter the textile 3 is washed by soap so as to remove corroded portion of the decorative cloth 4, thus forming patterns, shape, letters on the textile 3.

While the preferred embodiments of the invention have been set forth for the purpose of disclosure, modifications of the disclosed embodiments of the invention as well as other embodiments thereof may occur to skilled in the art. Accordingly, the appended claims are intended to cover all embodiments which do not depart from the spirit and scope of the invention.

What is claimed is:

1. A method of forming a three-dimensional decorative cloth on a textile comprising steps of:
providing a release paper, coating corrosion-resistant adhesive on one surface of the release paper in a screen printing manner, drying the corrosion-resistant adhesive;
providing a decorative cloth, adhering the corrosion-resistant adhesive of the release paper on one surface of the decorative cloth in a heat transfer printing manner;
providing a textile, forming an anticorrosive protection layer on one surface of the textile, removing the release paper from the decorative cloth, adhering the corrosion-resistant adhesive of the decorative cloth with the anticorrosive protection layer of the textile in a heat pressing manner;
forming a corrosion layer on the decorative cloth in a screen printing manner so as to corrode the decorative cloth; and
washing the textile by water so to eliminate the corrosion layer, and washing the textile by soap so as to remove corroded portion of the decorative cloth.

2. The method as claimed in claim 1, wherein the corrosion-resistant adhesive has lye consisting of PUR hot melt adhesive and sodium bicarbonate (NaHCO₃).

3. The method as claimed in claim 2, wherein the corrosion layer 6 is made of any one of trichloroacetic acid, nitric acid (HNO₃), sulfuric acid (H₂SO₄), manganic acid (H₂MnO₄), hypochlorous acid (HClO), chloric acid (HClO₃), bromic acid (HBrO₃), nitrous acid, oxalic acid (H₂C₂O₄), and ionic liquid.

4. The method as claimed in claim 3, wherein the corrosion layer corrodes the decorative cloth for 15 minutes to 25 minutes within a temperature of 125° C. to 135° C. so as to oxidize cotton cellulose of the decorative cloth and to destroy non-crystalline area structure.

5. The method as claimed in claim 1, wherein the anticorrosive protection layer is screen printed on the textile, and a profile of the anticorrosive protection layer corresponds to that of the decorative cloth.

6. The method as claimed in claim 2, wherein the anticorrosive protection layer is screen printed on the textile, and a profile of the anticorrosive protection layer corresponds to that of the decorative cloth.

7. The method as claimed in claim 3, wherein the anticorrosive protection layer is screen printed on the textile, and a profile of the anticorrosive protection layer corresponds to that of the decorative cloth.

8. The method as claimed in claim 4, wherein the anticorrosive protection layer is screen printed on the textile, and a profile of the anticorrosive protection layer corresponds to that of the decorative cloth.

9. The method as claimed in claim 1, wherein after adhering the corrosion-resistant adhesive of the release paper on the decorative cloth, the release paper and the decorative cloth are cut in a desired shape by using a digital engraving machine, the release paper is removed from the decorative cloth, and the decorative cloth is adhered on the textile in a heat pressing manner.

10. The method as claimed in claim 2, wherein after adhering the corrosion-resistant adhesive of the release paper on the decorative cloth, the release paper and the decorative cloth are cut in a desired shape by using a digital engraving machine, the release paper is removed from the decorative cloth, and the decorative cloth is adhered on the textile in a heat pressing manner.

11. The method as claimed in claim 3, wherein after adhering the corrosion-resistant adhesive of the release paper on the decorative cloth, the release paper and the decorative cloth are cut in a desired shape by using a digital engraving machine, the release paper is removed from the decorative cloth, and the decorative cloth is adhered on the textile in a heat pressing manner.

12. The method as claimed in claim 4, wherein after adhering the corrosion-resistant adhesive of the release paper on the decorative cloth, the release paper and the decorative cloth are cut in a desired shape by using a digital engraving machine, the release paper is removed from the decorative cloth, and the decorative cloth is adhered on the textile in a heat pressing manner.

13. A method of forming a three-dimensional decorative cloth on a textile comprising steps of:
providing a corrosion-resistant adhesive;
providing a decorative cloth, coating the corrosion-resistant adhesive on one surface of the decorative cloth;
providing a textile, forming an anticorrosive protection layer on one surface of the textile, removing the release paper from the decorative cloth, adhering the corrosion-resistant adhesive of the decorative cloth with the anticorrosive protection layer of the textile in a heat pressing manner;
forming a corrosion layer, screen printing manner the corrosion layer on the decorative cloth so as to corrode the decorative cloth; and
washing the textile by water so to eliminate the corrosion layer, and washing the textile by soap so as to remove corroded portion of the decorative cloth.

14. The method as claimed in claim 13, wherein the corrosion-resistant adhesive has lye consisting of PUR hot melt adhesive and sodium bicarbonate (NaHCO₃).

15. The method as claimed in claim 14, wherein the corrosion layer 6 is made of any one of trichloroacetic acid, nitric acid (HNO₃), sulfuric acid (H₂SO₄), manganic acid (H₂MnO₄), hypochlorous acid (HClO), chloric acid (HClO₃), bromic acid (HBrO₃), nitrous acid, oxalic acid (H₂C₂O₄), and ionic liquid.

16. The method as claimed in claim 15, wherein the corrosion layer corrodes the decorative cloth for 15 minutes to 25 minutes within a temperature of 125° C. to 135° C. so as to oxidize cotton cellulose of the decorative cloth and to destroy non-crystalline area structure.
